(19) United States
(12) Patent Application Publication
(10) Pub. No.: US 2026/0075468 A1
(43) Pub. Date: Mar. 12, 2026

(54) SYSTEMS, METHODS, AND DEVICES FOR MOBILE-ASSISTED QUALITY OF EXPERIENCE OPTIMIZATION FOR XRM

(71) Applicant: Apple Inc., Cupertino, CA (US)

(72) Inventors: Alosious Pradeep PRABHAKAR, Singapore (SG); Mohammad Amin MALEK, Baulkham Hills (AU); Muthukumaran DHANAPAL, San Diego, CA (US)

(21) Appl. No.: 18/827,617

(22) Filed: Sep. 6, 2024

(51) Int. Cl. H04W 28/24; H04L 41/5067; H04W 24/10

(52) U.S. Cl. CPC H04W 28/24; H04L 41/5067; H04W 24/10

(57) ABSTRACT

The techniques described herein can include solutions for mobile-assisted quality of experience (QoE) optimization for with extended reality (XR) and media (XRM). In some examples, a user equipment (UE) can receive, from a base station, an indication of periodicity for generating a QoE report associated with XRM traffic, the QoE report including QoE measurements and the periodicity spanning at least one sampling period for obtaining the QoE measurements. The UE can select, based on the XRM traffic, a sampling procedure for obtaining the QoE measurements, and obtain the QoE measurements during the at least one sampling period. The UE can generate the QoE report based on the QoE measurements. In some examples, the UE can transmit the QoE report to the base station. The base station can receive the QoE report and adjust network parameters accordingly.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fourth generation (4G), fifth generation (5G) or new radio (NR) technology. Such technology can include solutions for quality improvements.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example of an overview according to one or more implementations described herein.

FIG. 2 is a diagram of an example network according to one or more implementations described herein.

FIG. 3 is a diagram of an example process for mobile-assisted quality of experience (QoE) optimization for extended reality (XR) and media (XRM) according to one or more implementations described herein.

FIG. 4 is a diagram of an example process for mobile-assisted QoE optimization for XRM according to one or more implementations described herein.

FIG. 5 is a diagram of an example for mobile-assisted QoE optimization for XRM according to one or more implementations described herein.

FIG. 6 is a diagram of an example for mobile-assisted QoE optimization for XRM according to one or more implementations described herein.

FIG. 7 is a diagram of an example process for mobile-assisted QoE optimization for XRM according to one or more implementations described herein.

FIG. 8 is a diagram of an example for mobile-assisted QoE optimization for XRM according to one or more implementations described herein.

FIG. 9 is a diagram of an example for mobile-assisted QoE optimization for XRM according to one or more implementations described herein.

FIG. 10 is a diagram of an example of components of a device according to one or more implementations described herein.

FIG. 11 is a diagram of example interfaces of baseband circuitry according to one or more implementations described herein.

FIG. 12 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 13 is a diagram of an example process for mobile-assisted QoE optimization for XRM according to one or more implementations described herein.

FIG. 14 is a diagram of an example process for mobile-assisted QoE optimization for XRM according to one or more implementations described herein.

FIG. 15 is a diagram of an example process for mobile-assisted QoE optimization for XRM according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Telecommunication networks can include user equipment (UEs) capable of communicating with base stations and/or other network access nodes. UEs and base stations can implement various techniques and communications standards for enabling UEs and base stations to discover one another, establish and maintain connectivity, and exchange information in an ongoing manner. Objectives of such techniques can include quality of experience (QoE) report optimization, such as for extended reality (XR) and media (XRM) applications.

XRM can include augmented reality (AR), virtual reality (VR), and mixed reality (MR), where the physical world has sensory additions, an entire virtual world is constructed, or a mix of both. For example, XR can include acoustic and audio sensory additions, as well as haptic interactions for the user. XRM can further include media, such as downloading content, messaging, image sharing, video streaming, video calls, voice calls, content upload, etc. Due to the volume of data flows required to maintain high-quality sensory additions, XRM applications can depend upon real-time delivery of data in order to create a high quality of experience (QoE) for the user. Delay, among other factors, can negatively impact QoE of the user. For example, such as if a user is participating in a VR application, delay of audio and visual component can cause a disjointed and frustrating experience for the user.

In some examples, the network (e.g., base station) can schedule the UE to send QoE reports according to a periodicity. The UE can indicate QoE reports at each period, or report period, as indicated by the periodicity. Each report period can include sampling periods, during which the UE can perform measurements related to a quality of an experience of a user (e.g., QoE measurement). Examples of such measurements can include average throughout, transmission delay, reception delay, latency, jitter, buffer level, power use, signal quality, signal strength, playout delay, play list, comparable quality viewport switching latency, rendered viewports, etc. The UE can indicate the QoE measurements to the base station via a QoE report. Thus, the UE can perform (e.g., sample, determine, calculate, etc.) measurements for multiple metrics during one or more sampling periods of the report period, and can indicate the measurements as part of the QoE report at each report period. The base station can optimize scheduling of resources, such as increasing or decreasing resources, based on the QoE reports from the UE.

Performing QoE measurements can involve the use of processing and transmission of resources, including battery power. In some examples, such as in uplink congested scenarios, over the air (OTA) messages can be prioritized over QoE reports. For example, UE 210 can dedicate limited resources to transmitting OTA messages, and refrain from transmitting QoE reports. However, a reduction of QoE reports can result in reduced quality of user experience as the network would be unable to respond to QoE conditions.

One or more of the techniques described herein address the foregoing deficiencies by providing solutions for optimizing QoE reports according to various conditions. For example, the UE can refrain from performing measurements, refrain from indicating QoE reports, discard stale reports, or a combination thereof. By refraining from performing measurements, refraining from indicating QoE reports, or both, the UE can optimize the use of processing and transmission battery power resources.

In some examples, the UE can refrain from performing measurements during one or more sampling periods according to different sampling procedures, scenarios, channel conditions, or a combination thereof. Examples of different scenarios can include the use of different types of XRM applications, which can involve passive streaming, interactive streaming, video games, and more. Channel conditions can vary in quality. The UE can select a sampling procedure, or pattern of sampling period skipping, to optimize QoE reports based on XRM scenarios, channel conditions, or both.

In some examples, the UE can refrain from generating and/or communicating a QoE report during a respective report period. For example, the UE may not receive an acknowledgement (ACK) message from the base station indicating successful receipt of a QoE report. In such examples, the UE can refrain from triggering a radio link failure (RLF) response and can refrain from indicating the subsequent QoE report based on the failure of the prior report. The UE can indicate QoE reports and refrain from indicating QoE reports based on patterns of ACK messages and lack of ACK messages.

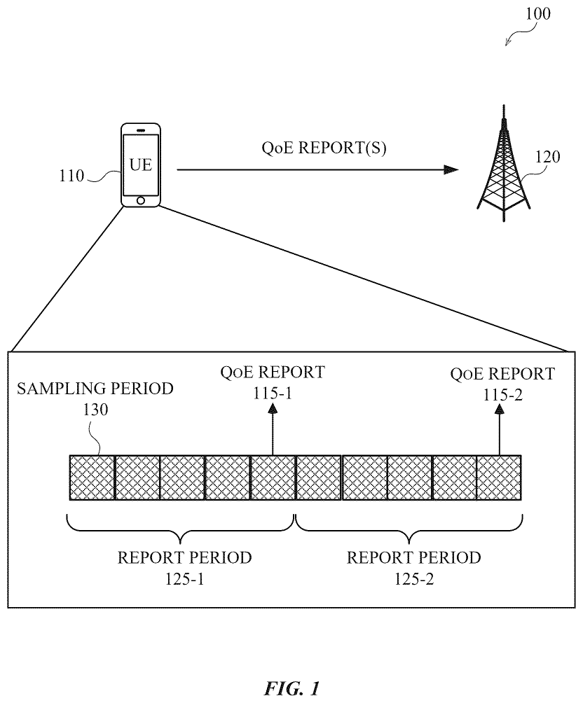

FIG. 1 is a diagram of an example of an overview 100 according to one or more implementations described herein. UE 110 can communicate QoE reports 115-1, 115-2, etc., to base station 120. QoE reports can include measurements collected during sampling periods 130 during a corresponding report period 125-1, 125-2, etc.

In some examples, UE 110 can receive a periodicity defining report periods 125 from base station 120. The periodicity can be included as part of ran-VisiblePeriodicity-r17, and can be defined in milliseconds (ms) (e.g., 120 ms, 140 ms, 480 ms, 640 ms, 1024 ms). Each report period 125 can include multiple sampling periods 130. During each report period 125, UE 110 can indicate a QoE report based on the measurements performed during the respective report period 125. For example, QoE report 115-1 can be based on the measurement of report period 125-1 and QoE report 115-2 can be based on the report period of 125-2. In some examples, QoE report 115 can be indicated via MeasurementReportAppLayer.

UE 110 can select a sampling procedure, or pattern of skipping performing measurement during sampling periods, to optimize QoE reports 115 based on XRM scenarios, channel conditions, etc. For example, for a passive streaming scenario, UE 110 can be primarily receiving downlink content, and can select a sampling procedure that skips, or refrains from, performing QoE measuring during most of the sampling periods 130 of report period 125 (e.g., skip all sampling procedures). In another example, for a video gaming scenario, downlink communications are consistent, and UE 110 can select a sampling procedure that skips every other sampling period 130 (e.g., interval sampling procedure) when network conditions are acceptable (e.g., good/moderate), and can select a sampling procedure that samples at every sampling period 130 (e.g., default sampling procedure) when channel conditions are unacceptable (e.g., poor/bad).

In some examples, UE 110 can refrain from transmitting one or more QoE reports 115 or skip one or more QoE reports 115. For example, UE 110 may not receive an ACK message following QoE report 115. UE 110 may not trigger RLF but can instead determine whether to skip the following QoE report 115 based on the number of previously failed reports and skipped reports. For example, UE 110 can skip QoE report 115-1 after two failed QoE reports 115. After skipping QoE report 115-1, UE 110 can indicate QoE report 115-2 based on skipping QoE report 115-1.

In some examples, UE 110 can discard older, or stale, QoE measurements. In some examples, UE 110 can receive instructions from base station 120 to pause transmission of QoE reports 115, or to pause reporting. The instruction to pause reporting can be received when UE 110 has indicated some, but not all, of the segments of QoE report 115. That is, UE 110 can have stored QoE measurements that are not scheduled to be indicated in a QoE report 115. To retain memory space, UE 110 can discard information (e.g., bytes of information) that exceed a threshold (e.g., storage threshold). For example, UE 110 can maintain a defined portion of QoE measurements and discard any older QoE measurements. In some examples, UE 110 can discard older QoE measurements after each report period 125.

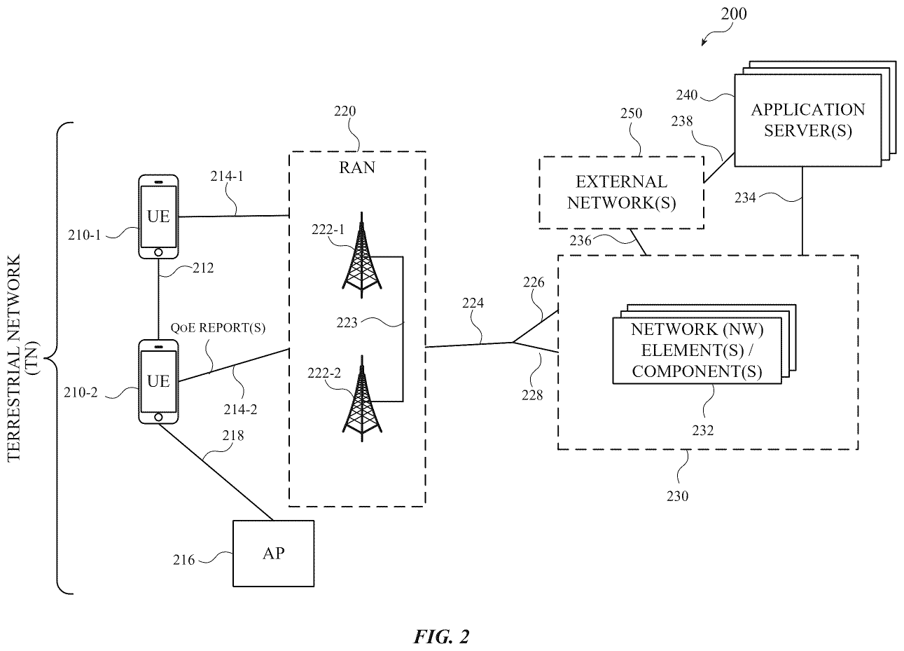

FIG. 2 is an example network 200 according to one or more implementations described herein. Example network 200 can include UEs 210-1, 210-2, etc. (referred to collectively as “UEs 210” and individually as “UE 210”), a radio access network (RAN) 220, a core network (CN) 230, application servers 240, and external networks 250.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, virtual reality (VR) headsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, communications (e.g., to exchanging data with a machine-type communications server or other device via a public land mobile network (PLMN)), proximity-based service (ProSe) or device-to-device (D2D) communications, sensor networks, IoT networks, and more. Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network.

UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can involve a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with (e.g., be communicatively coupled) with RAN 220, which can involve one or more wireless channels 214-1 and 214-2, each of which can comprise a physical communications interface/layer. In some examples, UE 210 can indicate one or more QoE reports via wireless channel 214-2. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different RAN network nodes (e.g., RAN network nodes 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network RAN network nodes.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection interface 218 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. A RAN node 222 can be a base station and can be referred to herein as base station 222. RAN nodes 222 can include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

One or more of the techniques, described herein, can enable UE 210 to optimize QoE reports for XRM. For example, UE 210 can refrain from performing measurements at one or more sampling periods of a report period at which a QoE report is indicated. In some examples, UE 210 can refrain from transmitting one or more QoE reports based on prior report failure and transmissions. Further, UE 210 can discard older, or stale, QoE measurements. These and many other features and aspects of the techniques described herein are presented below with reference to remaining Figures.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. The RAN nodes 222 can be configured to communicate with the CN 230 via various interfaces, such as physical interfaces, including interface 224, interface 226, and interface 228.

In some implementations, the X2 interface can include an X2 user plane interface (X2-U) and an X2 control plane interface (X2-C). The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CN 230 (e.g., universal mobile telecommunications system packet services (UMTS PS) domain, LTE PS data services, etc.). Application servers 240 can also, or alternatively, be configured to support one or more communication services (e.g., voice over IP (VoIP) sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

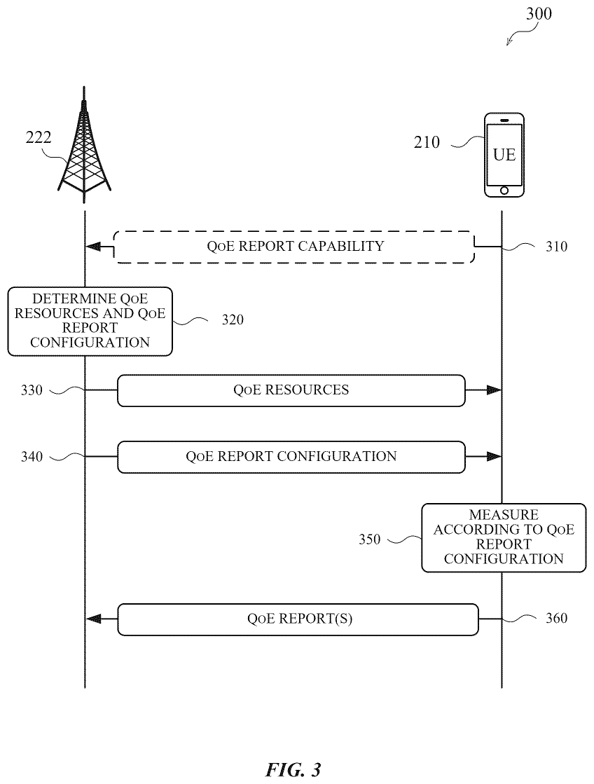

FIG. 3 is a diagram of an example of process 300 for mobile-assisted QoE optimization for XRM according to one or more implementations described herein. Process 300 can be implemented by UE 210. In some implementations, some or all of process 300 can be performed by one or more other systems or devices, including one or more of the devices of FIG. 2. Additionally, process 300 can include one or more fewer, additional, differently ordered and/or arranged operations than those shown in FIG. 3. In some implementations, some or all of the operations of process 300 can be performed independently, successively, simultaneously, etc., of one or more of the other operations of process 300. As such, the techniques described herein are not limited to a number, sequence, arrangement, timing, etc., of the operations or processes depicted in FIG. 3.

As shown, process 300 can include UE 210 indicating (e.g., transmitting) a QoE report capability to base station 222 (at 310). The QoE report capability can include the capability of the UE 210 to indicate QoE reports for XRM applications, such as supported measurements and periodicity. In some examples, UE 210 can request resources for QoE reporting.

Process 300 can also include base station 222 determining resources and configuration for QoE reports (at 320). For example, base station 222 can select one or more resources and a periodicity for QoE reporting (e.g., a report period). Process 300 can include base station 222 indicating resources to UE 210 for QoE reports (at 320). Base station 222 can also indicate a QoE report configuration, which can include the periodicity for QoE reporting (at 330). In some examples, QoE report configuration can include which QoE measurements to perform. In some examples, UE 210 determines which measurements to perform.

Process 300 can include UE 210 performing one or more measurements according to the configuration of resources and the periodicity (at 350). In some examples, UE 210 can skip, or refrain from measuring, according to a sampling procedure. UE 210 can indicate the measurements to base station 222 via QoE reports (at 360). In some examples, UE 210 can refrain from transmitting one or more QoE reports.

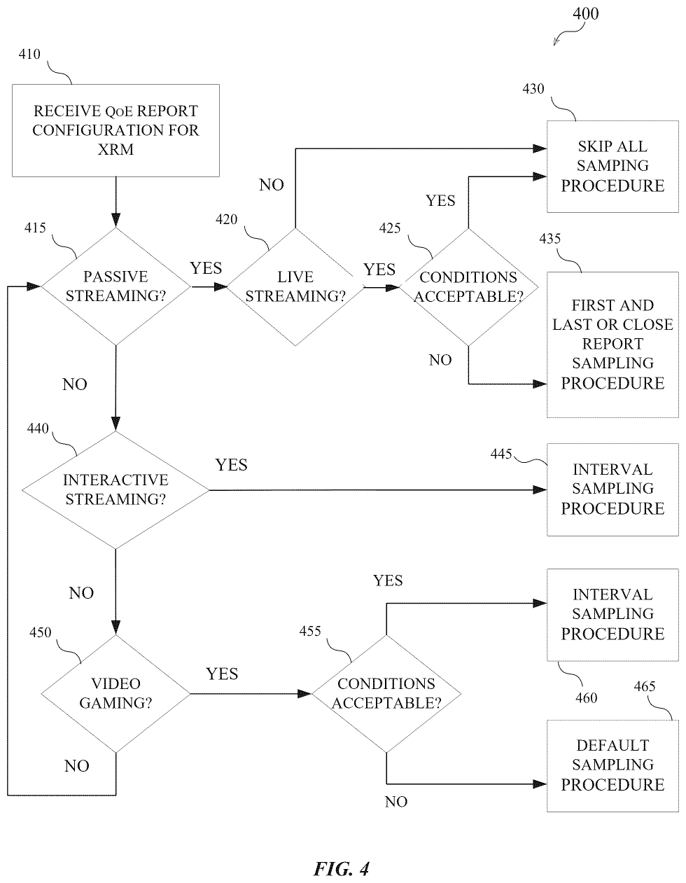

FIG. 4 is a diagram of an example of process 400 for mobile-assisted QoE optimization for XRM according to one or more implementations described herein. Process 400 can be implemented by UE 210. In some implementations, some or all of process 400 can be performed by one or more other systems or devices, including one or more of the devices of FIG. 2. Additionally, process 400 can include one or more fewer, additional, differently ordered and/or arranged operations than those shown in FIG. 4. In some implementations, some or all of the operations of process 400 can be performed independently, successively, simultaneously, etc., of one or more of the other operations of process 400. As such, the techniques described herein are not limited to a number, sequence, arrangement, timing, etc., of the operations or processes depicted in FIG. 4.

Process 400 can include XR scenario-based sampling procedure selection. Depending on the XR scenario (e.g., XR traffic class), process 400 can include selecting a proprietary methodology to sample and report QoE metrics to base station 222 (e.g., the network). In some examples, process 400 can include considering channel conditions in addition to scenarios (e.g., traffic class, traffic).

Scenarios (e.g., traffic class, traffic) can include XR applications, such as passive streaming, interactive streaming, and video gaming. Network conditions can include reference signal received power (RSRP), signal strength, signal-to-noise ratio (SNR), signal interference, transmission power, measured received power, and allocated time and frequency resources, packet loss, jitter, error rate, and/or delay budget, among other factors.

The network conditions can be of varying quality, and can be described as acceptable (e.g., good, moderate) or unacceptable (e.g., poor, bad). In some examples, sampling procedure selection can be based on an acceptability threshold determining whether network conditions are unacceptable or acceptable. For example, network conditions exceeding the acceptability threshold can be defined as acceptable, and network conditions below the acceptability threshold can be defined unacceptable.

Process 400 can include receiving QoE report configuration for XRM (at 410). For example, the network, or base station 222, can configure UE 210 to report QoE reports for XRM. In some examples, QoE report configuration can include a periodicity of QoE reporting. In some examples, base station 222 can configure the measurements to be performed for QoE reports. In some examples, UE 210 can determine which measurements to perform. In some examples, UE 210 can be standalone (SA) and be XR capable.

Process 400 can include determining whether a situation involves passive streaming (at 415). Passive streaming can include scenarios where content is primarily downloaded, such as when a user is watching a video. In such examples, the QoE measurements can be reported to the network as part of a QoE report, and the network can use the QoE report to upgrade or downgrade content quality.

When the scenario is passive streaming (block 415—YES), process 400 can include determining whether the passive streaming scenario is live streaming (at 420). Live streaming can include real-time downloading of content. When the situation does not involve live streaming (block 420—NO), process 400 can include implementing a skip all sampling procedure (at 430). A skip all sampling procedure can include performing measurements only during the last sampling period of the report period for the QoE report and skipping prior sampling periods of the report period.

When the scenario is live streaming (block 420—YES), process 400 can include determining network conditions (at 425). When the channel conditions are acceptable (e.g., good, based on the acceptable threshold) (block 425—YES), process 400 can include implementing a skip all sampling procedure (at 430). When channel conditions are not acceptable, or unacceptable (e.g., moderate or poor, based on the acceptable threshold) (block 425—NO), process 400 can include implementing a first and last sampling procedure, a close report sampling procedure, or both (at 435). A first and last sampling procedure can include measuring during the first and last sampling periods of a report period, and a close report sampling procedure can include measuring during the final two sampling periods of the report period and skipping prior sampling periods of the report period.

For example, UE 210 can implement the skip all sampling procedure for passive streaming scenarios. The skip all sampling procedure can be sufficient due to the one-way nature of the content. For the specific scenario of live streaming, UE 210 can implement the skip all sampling procedure when network conditions are acceptable and implement the first and last sampling procedure or close report sampling procedure when network conditions are unacceptable. More sampling can be used for live streaming, and when network conditions are unacceptable, there are fewer resources available, and it can be more advantageous to measure less frequently.

Process 400 can include determining that the scenario is not passive streaming (block 415—NO) and determine whether the scenario is interactive streaming (at 440). Process 400 can include determining that the scenario is interactive streaming (block 440—YES). Interactive streaming can include consistent upload and download throughout the session (e.g., FaceTime, video conferencing, etc.). Interactive streaming can include synchronized audio and video data packets that can be indicated as a set of packet data units. For interactive streaming, process 400 can include an interval sampling procedure (at 445). For example, UE 210 can perform measurements during every other sampling period, or skip performing measurements at every other sampling period. UE 210 can implement an interval sampling procedure for all network conditions. In some examples, base station 222 can use the QoE reports to enhance resource scheduling.

Process 400 can include determining that the scenarios not interactive streaming (at 440—NO) and then determine whether the scenario is video gaming. When the scenario is not video gaming (at 450—NO), process 400 can include returning to determine whether the scenario is passive streaming (at 415). When the scenario is video gaming (at 450—YES), process 455 can include determining network conditions. A video gaming scenario can include cloud video gaming, video gaming with additional accessories, such as accessories with multiple degrees of freedom (e.g., 3DoF and 6DoF inputs), among other examples. In such examples, there can be consistent download throughout the session and uplink is usually the sensor inputs. Audio, video, and sensor packets can be synchronized and transferred as a set of packet data units, and the QoE report can be used to enhance resource scheduling and computing.

When network conditions are acceptable (e.g., good, moderate) (at 455—YES) process 400 can include implementing an interval sampling procedure (at 460). When network conditions are unacceptable (e.g., poor/bad) (at 455—NO) process 400 can include implementing a default sampling procedure (at 465). A default sampling procedure can include performing QoE measurements at every sampling period of a report period.

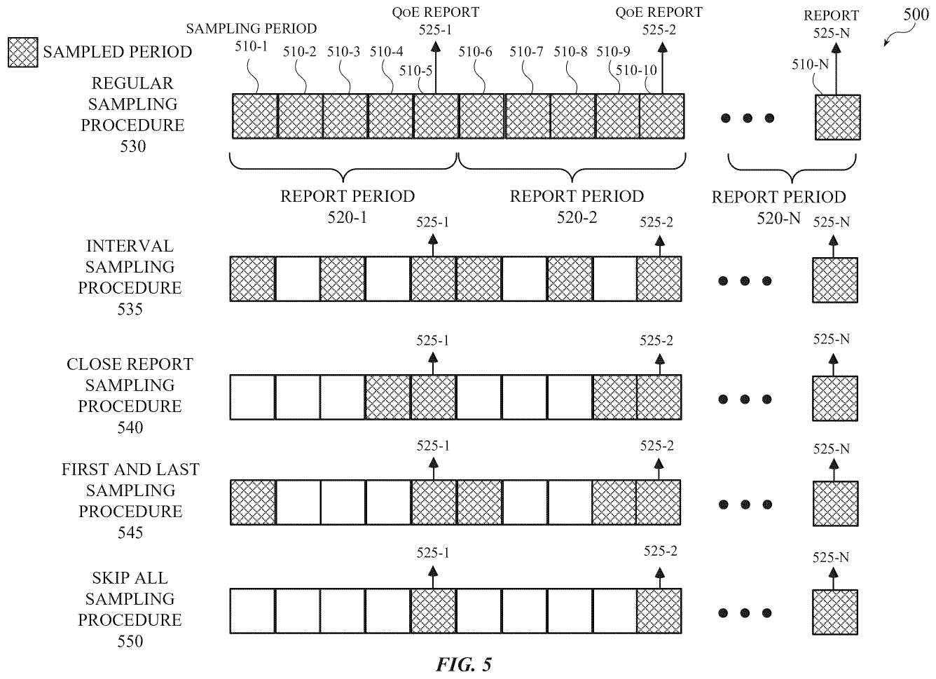

FIG. 5 is a diagram of an example 500 for mobile-assisted QoE optimization for XRM according to one or more implementations described herein. Example 500 depicts various sampling procedures for measurements to be transmitted as spart of a QoE report. Various sampling procedures can optimize QoE.

For example, report period 520 can describe the time during which QoE measurements are sampled (e.g., performed) and QoE report 525 is sent. QoE report 525 can be a QoE report of the sampled measurements of report period 520. In some examples, QoE report 525 can be an average of measurements across multiple report periods 520. Each report period 520 can including sampling periods 510. Sampling periods 510 are intervals time at which UE 210 may or may not sample measurements. By refraining from sampling, or skipping sampling, UE 210 can save resources.

Report period 520 can be various lengths of time, such as 120 ms, 240 ms, 580 ms, 640 ms, and 1024 ms, among other examples. The periodicity, or length of report period 520, can be defined by a parameter indicated to UE 210 by base station 222, such as part of the parameter ran-VisitblePeriodicity-r17. In some examples, sampling period 510 can be 100 ms. FIG. 5 describes a report period 520 of 480 ms, where each report period 520 includes five sampling periods 510 of 100 ms. However, techniques described with reference to FIG. 5 can be applied to other report period 520 lengths. For example, when report period 520 is 480 ms, there can be five sampling periods 510.

As described with reference to FIG. 5, for each sampling procedure, there can be multiple report periods 520, such as report period 520-1, 520-2, . . . 520-n. Report periods 520 can include sampling periods 510, such as sampling period 510-1, 510-2, 510-3, . . . 510-N QoE report 525 (e.g., QoE report 525-1, 525-2, . . . 525-n) can be indicated for each report period 520. For example, report period 520-1 can include sampling periods 510-1, 510-2, 510-3, 510-4, and 510-5. After report period 520-1, QoE report 525-1 can be transmitted. For example, UE 210 can sample, or refrain from sampling, at sampling period 510-1, 510-2, 510-3, 510-4, and 510-5, and transmit QoE report 520-1 during or after sampling period 510-5. Similarly, report period 520-2 can include sampling periods 510-6, 510-7, 510-8, 510-9, and 510-10, and report 525-2 can be transmitted. For example, UE 210 can sample, or refrain from sampling, at sampling period 510-6, 510-7, 510-8, 510-9, and 510-10, and transmit report 525-2 during or after sampling period 510-10.

Regular sampling procedure 530 can include sampling at each sampling period 510 and indicating a report for each report period 520. For example, UE 210 can receive an indication of the periodicity, or length of report period 520, from base station 222. UE 210 can sample and indicate QoE reports 525 according to the indication from base station 222.

Interval sampling procedure 535 can include sampling every other sampling period 510. In other words, skipping sampling every 100 ms. For example, UE 210 can sample sampling period 510-1, skip sampling at sampling period 510-2, sample at sampling period 510-3, skip sampling at sampling period 510-4, etc. UE 210 can average the measurements taken over the report period 520-1 and indicate the averages as part of QoE report 525. For example, UE 210 can sample at sampling periods 510-1, 510-3, and 510-5, and average the measurements for those sampling period 510 as part of QoE report 525-1.

Close report sampling procedure 540 can include sampling the last two sampling periods 510 of report period 520 and averaging the sampling over the report period 520. For example, UE 210 can sample sampling period 510-4 and sampling period 510-5 for report period 520-1 and average the samples for QoE report 525-1. First and last sampling procedure 545 can includes sampling the first and last intervals, or sampling periods 510, of the report period 520, and averaging the samples over the report period 520. For example, UE 210 can sample sampling period 510-1 and sampling period 510-5 of report period 520-1. UE 210 can average the first and last sampling as part of QoE report 525-1. Skip all sampling procedure 550 can include sampling the last interval, or sampling period 510, of the report period 520. For example, UE 210 can sample only sampling period 510-5 of report period 510-1.

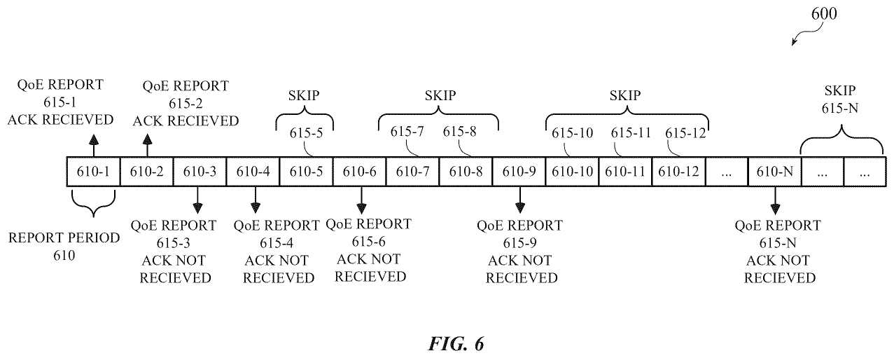

FIG. 6 is a diagram of an example 600 for mobile-assisted QoE optimization for XRM according to one or more implementations described herein. Example 600 describes optimization of QoE reports 615. In some examples, QoE reports 615 can be scheduled to be sent via a parameter, such as the parameter MeasurementReportAppLayer. QoE reports 615 can be indicated by a periodicity, (or sampling period) using a parameter or information element (IE), such as ran-VisiblePeriodicity-r17. For example, UE 210 can receive QoE report scheduling information and a QoE report periodicity from base station 222.

In response to UE 210 transmitting QoE report 615, UE 210 can receive a radio link control (RLC) acknowledge (ACK) message from base station 222, indicating that QoE report 615 was successfully received. In some example, UE 210 may not receive an ACK message, and can either resend the report or UE 210 can discard the QoE report 615 and send the following QoE report 615 (e.g., discard the old QoE report 615 and transmit a new QoE report 615).

In some examples, such as when an ACK is not received, UE 210 may not trigger a radio link failure (RLF). That is, a QoE reporting failure may not trigger RLF. Refraining from triggering an RLF can be applicable to scenarios, such as when downlink is primarily utilized and uplink is not primarily utilized. RLF can be delayed until other messages are affected, such as when an ACK is not received for a QoE report 615 and other uplink messages are not affected.

In some examples, incremental pausing can be implementing for scenarios when an ACK is not received after transmitting QoE report 615. Incremental pausing can include skipping the indication of one or more QoE reports 615, and can be applicable to many scenarios, such as uplink limited communications, bad radio frequency conditions, extreme temperatures, low battery, low power mode, and congestion, among other examples. QoE reports 615 can be indicated for each report period 610, or QoE reports 615 can be skipped for each report period 610.

For example, FIG. 6 describes incremental pausing where the number of skipped QoE reports 615 increases by one QoE report 615 for each failed QoE report 615. For example, QoE report 615-1 can be transmitted during the first report period 610-1 and QoE report 615-2 can be transmitted during the second report period 610-2. An ACK can be received for both QoE report 615-1 and 615-2. QoE report 615-3 can be transmitted during report period 610-3 though an ACK may not be received for QoE report 615-3. UE 210 can transmit the next QoE report 615-4, and if this also does not receive an ACK, UE 210 can skip the following QoE report 615-5. UE 210 can send the following QoE report 615-6 and may not receive an ACK for QoE 615-6. In response, UE 210 can determine to skip two QoE reports 615 (QoE report 615-7 and QoE report 615-8). UE 210 can transmit QoE report 615-9, which may not receive an ACK. In response to the failed QoE report 615-9, UE 210 can skip the three following QoE reports 615, QoE report 615-10, QoE report 615-11, and QoE report 615-12. Then, UE 210 can continue this pattern of transmitting a QoE report 615 and skipping the following QoE report 615 based on the previous failures.

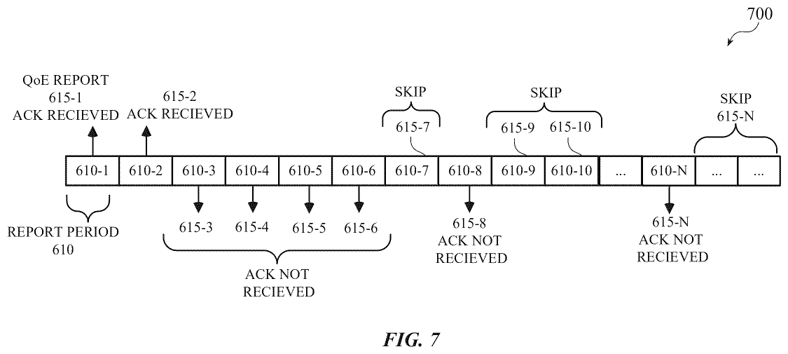

FIG. 7 is a diagram of an example 700 for mobile-assisted QoE optimization for XRM according to one or more implementations described herein. Example 700 describes optimization of QoE reports 615. In some examples, FIG. 7 can be an alternative example of FIG. 6. FIG. 7 describes another example of skipping QoE reports 615. In contrast to example 600 of FIG. 6, UE 210 can transmit many (e.g., four) QoE reports 615 without receiving an ACK, prior to skipping subsequent QoE reports 615. For example, UE 210 can send failed reports QoE reports 615-3, 615-4, 615-5, and 615-6 before skipping QoE report 615-7. UE 210 can then implement the pattern as described with reference to FIG. 6, incrementally increasing the number of skipped QoE reports 615 with each failure.

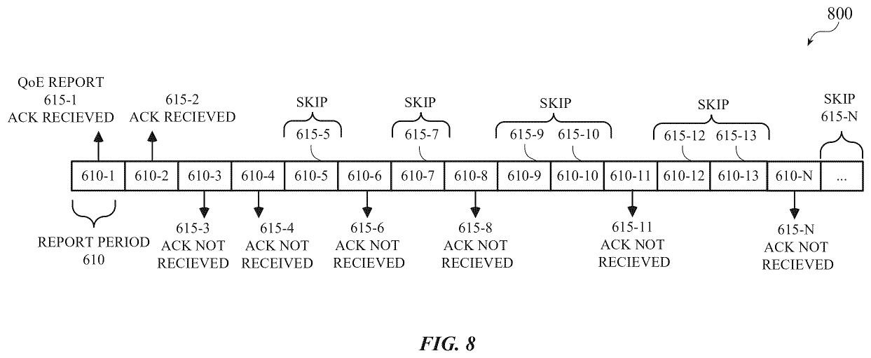

FIG. 8 is a diagram of an example 800 for mobile-assisted QoE optimization for XRM according to one or more implementations described herein. Example 800 describes optimization of QoE reports 615. In some examples, FIG. 8 can be an alternative example of FIG. 6. FIG. 8 describes an example of a pattern, where the number of skipped QoE reports 615 is not increased until a specified number of consecutive QoE reports fail (e.g., for which an ACK is not received). Example 800 includes two consecutive failures though a different number of consecutive failures can be implemented. For example, QoE report 615-5 can be skipped after both QoE report 615-3 and QoE report 615-4 fail. UE 210 can transmit QoE report 615-6, and if QoE report 615-6 also fails, skip QoE report 615-7. UE 210 can transmit QoE report 615-8, and upon failure, skip two QoE reports 615, QoE report 615-9 and QoE report 615-10. UE 210 can fail to receive an ACK for two more QoE report 615 before increasing the number of skipped QoE reports 615. Accordingly, the techniques escribed herein can include one or more of a variety of patterns and parameters for staggering the transmission of QoE reports 615 in response to failing to receive an ACK for one or more QoE reports 615.

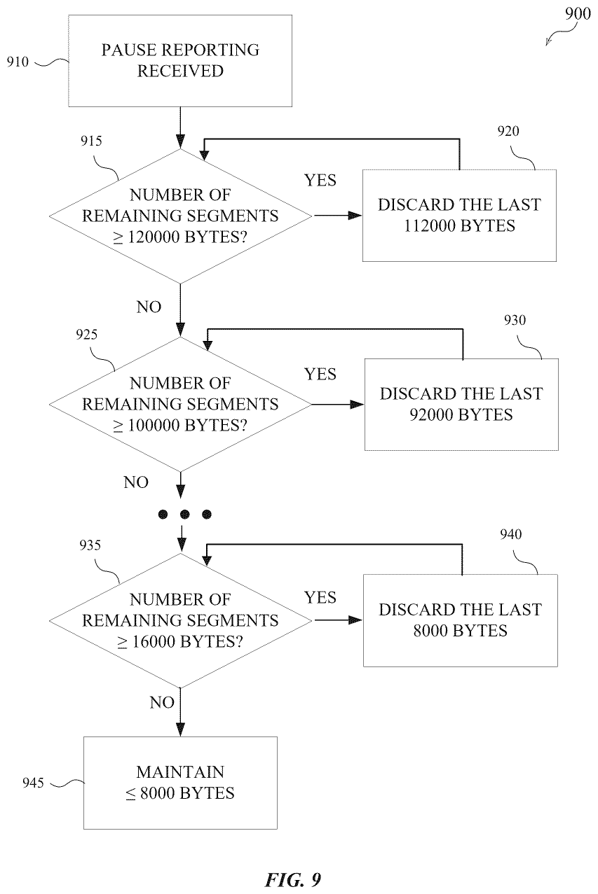

FIG. 9 is a diagram of an example process 900 for mobile-assisted QoE optimization for XRM according to one or more implementations described herein. FIG. 9 describes UE 210 QoE report discarding. UE 210 can receive configuration information from base station 222, indicating for UE 210 to refrain from transmitting QoE reports for a period of time. In some examples, a pause reporting configuration can be received after a portion, or segment, of a QoE report has been sent (e.g., before completion, or indication, all segments of a MeasuremeentReportAppLayer). In such examples, UE 210 can continue to collect measurements for a paused QoE report that will not be sent. To optimize memory storage, UE 210 can discard old report measurements. In some examples, UE 210 can discard old report measurements based on a storage threshold.

Process 900 can include discarding stale, or old, reports based on time. In such examples, UE 210 can be collect measurements without transmitting them, resulting in limited or full memory. Thus, UE 210 can discard stale, or old, measurements in order to optimize memory usage (e.g., maintain 8,000 bytes or another threshold amount of memory). While FIG. 9 is described with reference to specific numbers of bytes, techniques described herein can be applied to any number of bytes. In some examples, the number of bytes can be a storage threshold. For example, UE 210 can discard bytes that exceed the storage threshold.

Process 900 can include pausing of reporting of QoE reports (at 910). For example, UE 210 can receive notification from the network, such as base station 222, to refrain from reporting QoE reports for a period of time. In some examples, the notification to pause QoE reporting can be received after the start of transmission of a QoE report and before the entire QoE report has been transmitted.

Process 900 can include determining whether the number of remaining segments of a QoE report that have not been transmitted is greater than or equal to 120,000 bytes (at 915) (e.g., exceeds the storage threshold). When the number of remaining segments is greater than 120,000 bytes (at 915—YES) the last, or oldest, 112,000 bytes can be discarded (at 920). After discarding bytes, process 900 can include repeating the comparison of the number of remaining segments to 120,000 bytes (at 915). In this way, the number of bytes is reduced to less than 120,000 bytes before being compared to a lower number of bytes.

Process 900 can include, when the number of remaining segments is less than 120,000 bytes (at 915—NO), determining whether the number of remaining segments is greater than or equal to 100,000 bytes. When the number of remaining segments is greater than 100,000 bytes (at 925—YES), the last 92,000 bytes can be discarded (at 930). After discarding bytes, process 900 can include repeating the comparison of the number of remaining segments to 100,000 until there are less than 100,000 bytes (at 925).

Process 900 can include, when the number of remaining segments does not exceed 100,000 bytes (at 925—NO), continuing to compare the number of remaining segments to an incrementally decreasing numbers of bytes (e.g., by 20,000, 10,000, 8,0000, etc.) and discarding bytes accordingly. To maintain 8,000 bytes, process 900 can include comparing the number of remaining segments to 16,000 bytes (at 935). When the number of remaining segments is greater than or equal to 16,000 bytes, and less than the previous comparison, the last 8,000 bytes can be discarded (at 940). The number of remaining segments can again be compared to 16,000, until there are less than 16,000 remaining segment bytes (at 935—NO). When the number of remaining bytes is less than 16,000 bytes, 8,000 bytes can be maintained. For example, the difference between the remaining number of bytes and 8,000 can be discarded in order to maintain 8,000 bytes (e.g., if there are 14,000 bytes, discard 6,000).

In some examples, such as when UE 210 receives an indication to pause reporting, UE 210 can periodically discard any segments exceeding 8,000 bytes. For example, UE 210 can, at each report period, maintain the most recent 8,000 bytes and discard any older bytes. Thus, UE 210 can maintain the lasted QoE metrics and maintain memory space.

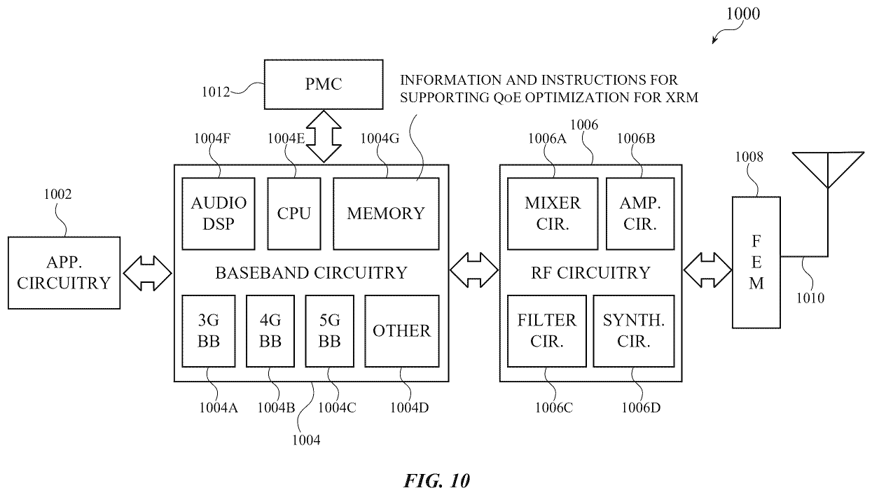

FIG. 10 is a diagram of an example of components of a device according to one or more implementations described herein. In some implementations, the device 1000 can include application circuitry 1002, baseband circuitry 1004, RF circuitry 1006, front-end module (FEM) circuitry 10010, one or more antennas 1010, and power management circuitry (PMC) 1012 coupled together at least as shown. The components of the illustrated device 1000 can be included in a UE or a RAN node. In some implementations, the device 1000 can include fewer elements (e.g., a RAN node may not utilize application circuitry 1002, and instead include a processor/controller to process IP data received from a CN or an Evolved Packet Core (EPC)). In some implementations, the device 1000 can include additional elements such as, for example, memory/storage, display, camera, sensor (including one or more temperature sensors, such as a single temperature sensor, a plurality of temperature sensors at different locations in device 1000, etc.), or input/output (I/O) interface. In other implementations, the components described below can be included in more than one device (e.g., said circuitries can be separately included in more than one device for Cloud-RAN (C-RAN) implementations).

The application circuitry 1002 can include one or more application processors. For example, the application circuitry 1002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1000. In some implementations, processors of application circuitry 1002 can process IP data packets received from an EPC.

The baseband circuitry 1004 can include circuitry such as, but not limited to, one or more single-core or multi-core processors. The baseband circuitry 1004 can include one or more baseband processors or control logic to process baseband signals received from a receive signal path of the RF circuitry 1006 and to generate baseband signals for a transmit signal path of the RF circuitry 1006. Baseband circuity 1004 can interface with the application circuitry 1002 for generation and processing of the baseband signals and for controlling operations of the RF circuitry 1006. For example, in some implementations, the baseband circuitry 1004 can include a 3G baseband processor 1004A, a 4G baseband processor 1004B, a 5G baseband processor 1004C, or other baseband processor(s) 1004D for other existing generations, generations in development or to be developed in the future (e.g., 5G, 6G, etc.).

The baseband circuitry 1004 (e.g., one or more of baseband processors 1004A-D) can handle various radio control functions that enable communication with one or more radio networks via the RF circuitry 1006. In other implementations, some or all of the functionality of baseband processors 1004A-D can be included in modules stored in the memory 1004G and executed via a Central Processing Unit (CPU) 1004E. The radio control functions can include, but are not limited to, signal modulation/demodulation, encoding/decoding, radio frequency shifting, etc. In some implementations, modulation/demodulation circuitry of the baseband circuitry 1004 can include Fast-Fourier Transform (FFT), precoding, or constellation mapping/de-mapping functionality. In some implementations, encoding/decoding circuitry of the baseband circuitry 1004 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1004G can receive and/or store information and instructions for enabling UE 210, and/or one or more components thereof, to optimize QoE reports for XRM. For example, the information and instructions can cause and/or enable UE 210 to determine whether to refrain from transmitting QoE reports, refrain from performing QoE measurements, and whether to discard stale QoE measurements.

In some implementations, the baseband circuitry 1004 can include one or more audio digital signal processor(s) (DSP) 1004F. The audio DSPs 1004F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1004 and the application circuitry 1002 can be implemented together such as, for example, on a system on a chip (SOC).

In some implementations, the baseband circuitry 1004 can provide for communication compatible with one or more radio technologies. For example, in some implementations, the baseband circuitry 1004 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1004 is configured to support radio communications of more than one wireless protocol can be referred to as multi-mode baseband circuitry.

RF circuitry 1006 can enable communication with wireless networks using modulated electromagnetic radiation through a non-solid medium. In various implementations, the RF circuitry 1006 can include switches, filters, amplifiers, etc. to facilitate the communication with the wireless network. RF circuitry 1006 can include a receive signal path which can include circuitry to down-convert RF signals received from the FEM circuitry 1008 and provide baseband signals to the baseband circuitry 1004. RF circuitry 1006 can also include a transmit signal path which can include circuitry to up-convert baseband signals provided by the baseband circuitry 1004 and provide RF output signals to the FEM circuitry 1008 for transmission.

In some implementations, the receive signal path of the RF circuitry 1006 can include mixer circuitry 1006A, amplifier circuitry 1006B and filter circuitry 1006C. In some implementations, the transmit signal path of the RF circuitry 1006 can include filter circuitry 1006C and mixer circuitry 1006A. RF circuitry 1006 can also include synthesizer circuitry 1006D for synthesizing a frequency for use by the mixer circuitry 1006A of the receive signal path and the transmit signal path. In some implementations, the mixer circuitry 1006A of the receive signal path can be configured to down-convert RF signals received from the FEM circuitry 1008 based on the synthesized frequency provided by synthesizer circuitry 1006D. The amplifier circuitry 1006B can be configured to amplify the down-converted signals and the filter circuitry 1006C can be a low-pass filter (LPF) or band-pass filter (BPF) configured to remove unwanted signals from the down-converted signals to generate output baseband signals. Output baseband signals can be provided to the baseband circuitry 1004 for further processing. In some implementations, the output baseband signals can be zero-frequency baseband signals, although this is not a requirement. In some implementations, mixer circuitry 1006A of the receive signal path can comprise passive mixers, although the scope of the implementations is not limited in this respect.

In some implementations, the mixer circuitry 1006A of the transmit signal path can be configured to up-convert input baseband signals based on the synthesized frequency provided by the synthesizer circuitry 1006D to generate RF output signals for the FEM circuitry 1008. The baseband signals can be provided by the baseband circuitry 1004 and can be filtered by filter circuitry 1006C.

In some implementations, the mixer circuitry 1006A of the receive signal path and the mixer circuitry 1006A of the transmit signal path can include two or more mixers and can be arranged for quadrature down conversion and up conversion, respectively. In some implementations, the mixer circuitry 1006A of the receive signal path and the mixer circuitry 1006A of the transmit signal path can include two or more mixers and can be arranged for image rejection (e.g., Hartley image rejection). In some implementations, the mixer circuitry 1006A of the receive signal path and the mixer circuitry 1006A can be arranged for direct down conversion and direct up conversion, respectively. In some implementations, the mixer circuitry 1006A of the receive signal path and the mixer circuitry 1006A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1006 can include analog-to-digital converter (ADC) and digital-to-analog converter (DAC) circuitry and the baseband circuitry 1004 can include a digital baseband interface to communicate with the RF circuitry 1006.

In some dual-mode implementations, a separate radio IC circuitry can be provided for processing signals for each spectrum, although the scope of the implementations is not limited in this respect. In some implementations, the synthesizer circuitry 1006D can be a fractional-N synthesizer or a fractional N/N+1 synthesizer, although the scope of the implementations is not limited in this respect as other types of frequency synthesizers can be suitable. For example, synthesizer circuitry 1006D can be a delta-sigma synthesizer, a frequency multiplier, or a synthesizer comprising a phase-locked loop with a frequency divider.

The synthesizer circuitry 1006D can be configured to synthesize an output frequency for use by the mixer circuitry 1006A of the RF circuitry 1006 based on a frequency input and a divider control input. In some implementations, the synthesizer circuitry 1006D can be a fractional N/N+1 synthesizer.

In some implementations, frequency input can be provided by a voltage-controlled oscillator (VCO), although that is not a requirement. Divider control input can be provided by either the baseband circuitry 1004 or the applications circuitry 1002 depending on the desired output frequency. In some implementations, a divider control input (e.g., N) can be determined from a look-up table based on a channel indicated by the applications circuitry 1002.

Synthesizer circuitry 1006D of the RF circuitry 1006 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1006D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1006 can include an IQ/polar converter.

FEM circuitry 1008 can include a receive signal path which can include circuitry configured to operate on RF signals received from one or more antennas 1010, amplify the received signals and provide the amplified versions of the received signals to the RF circuitry 1006 for further processing. FEM circuitry 1008 can also include a transmit signal path which can include circuitry configured to amplify signals for transmission provided by the RF circuitry 1006 for transmission by one or more of the one or more antennas 1010. In various implementations, the amplification through the transmit or receive signal paths can be done solely in the RF circuitry 1006, solely in the FEM circuitry 1008, or in both the RF circuitry 1006 and the FEM circuitry 1008.

In some implementations, the FEM circuitry 1008 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1006). The transmit signal path of the FEM circuitry 1008 can include a power amplifier (PA) to amplify input RF signals (e.g., provided by RF circuitry 1006), and one or more filters to generate RF signals for subsequent transmission (e.g., by one or more of the one or more antennas 1010).

In some implementations, the PMC 1012 can manage power provided to the baseband circuitry 1004. In particular, the PMC 1012 can control power-source selection, voltage scaling, battery charging, or DC-to-DC conversion. The PMC 1012 can often be included when the device 1000 is capable of being powered by a battery, for example, when the device is included in a UE.

The PMC 1012 can increase the power conversion efficiency while providing desirable implementation size and heat dissipation characteristics.

While FIG. 10 shows the PMC 1012 coupled only with the baseband circuitry 1004. However, in other implementations, the PMC 1012 can be additionally or alternatively coupled with, and perform similar power management operations for, other components such as, but not limited to, application circuitry 1002, RF circuitry 1006, or FEM circuitry 1008.

In some implementations, the PMC 1012 can control, or otherwise be part of, various power saving mechanisms of the device 1000. For example, if the device 1000 is in an RRC_Connected state, where it is still connected to the RAN node as it expects to receive traffic shortly, then it can enter a state known as Discontinuous Reception Mode (DRX) after a period of inactivity. During this state, the device 1000 can power down for brief intervals of time and thus save power.

If there is no data traffic activity for an extended period of time, then the device 1000 can transition off to an RRC_Idle state, where it disconnects from the network and does not perform operations such as channel quality feedback, handover, etc. The device 1000 goes into a very low power state and it performs paging where again it periodically wakes up to listen to the network and then powers down again. The device 1000 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1002 and processors of the baseband circuitry 1004 can be used to execute elements of one or more instances of a protocol stack. For example, processors of the baseband circuitry 1004, alone or in combination, can be used execute Layer 3, Layer 2, or Layer 1 functionality, while processors of the baseband circuitry 1004 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

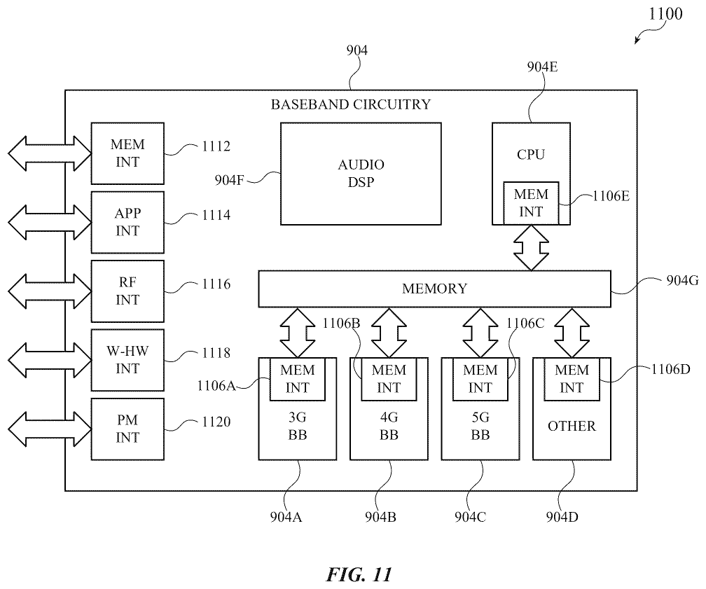

FIG. 11 is a diagram of example interfaces 1100 of baseband circuitry according to one or more implementations described herein. One or more components or features of example interfaces 1100 can correspond to one or more components or features described above or elsewhere. Baseband circuitry 904 can comprise processors 904A, 904B, 904C, 904D, and 904E and a memory 904G utilized by said processors. Each of the processors 904A, 904B, 904C, 904D, and 904E can include a memory interface, 906A, 906B, 906C, 906D, and 906E, respectively, to send/receive data to/from the memory 904G. Baseband circuitry can be a component of a UE and/or another type of device or system capable of transmitting and/or receiving wireless signals.

In some implementations, memory 1904G can receive, store, and/or provide information and instructions for QoE optimization for XRM. For example, base station 222 can indicate to UE 210 a periodicity for QoE reporting. In some examples, base station 222 can receive QoE reports from UE 210 and adjust accordingly.

Baseband circuitry 1104 can further include one or more interfaces to communicatively couple to other circuitries/devices, such as a memory interface 1112 (e.g., an interface to send/receive data to/from memory external to baseband circuitry 1104), an application circuitry interface 1114 (e.g., an interface to send/receive data to/from the application circuitry as described herein), an RF circuitry interface 1116, a wireless hardware connectivity interface 1118 (e.g., an interface to send/receive data to/from Near Field Communication (NFC) components, Bluetooth® components (e.g., Bluetooth® Low Energy), Wi-Fi® components, and other communication components), and a power management interface 1120 (e.g., an interface to send/receive power or control signals to/from a PMC)

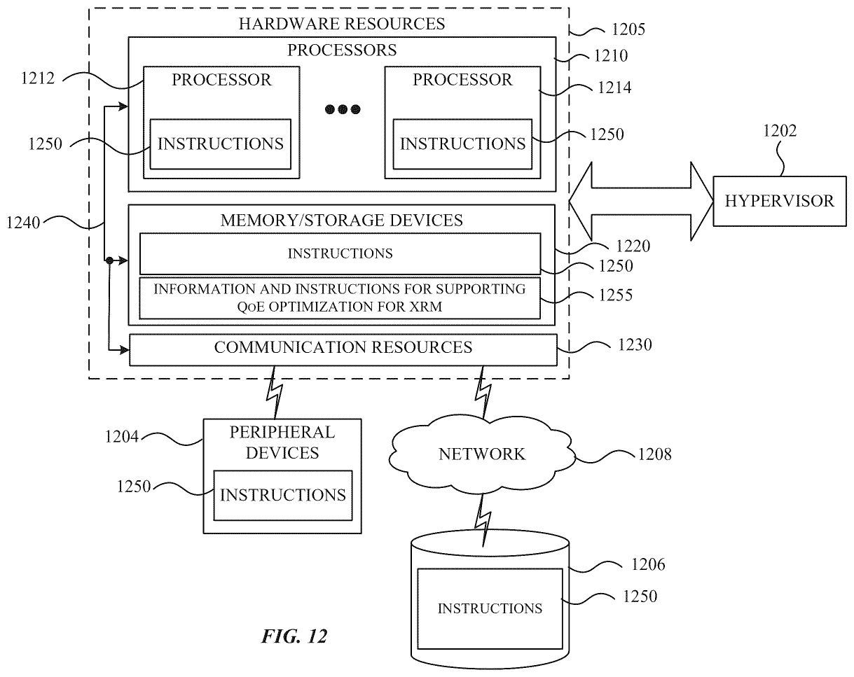

FIG. 12 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 12 shows a diagrammatic representation of hardware resources 1205 including one or more processors (or processor cores) 1210, one or more memory/storage devices 1220, and one or more communication resources 1230, each of which can be communicatively coupled via a bus 1240. For implementations where node virtualization (e.g., NFV) is utilized, a hypervisor can be executed to provide an execution environment for one or more network slices/sub-slices to utilize the hardware resources 1205.

The processors 1210 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1212 and a processor 1214.

The memory/storage devices 1220 can include main memory, disk storage, or any suitable combination thereof. The memory/storage devices 1220 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1220 receive and/or store information and instructions 1255 for QoE optimization for XRM. For example, processors can determine whether to refrain from performing QoE measurements, indicating QoE reports, and to discard stale QoE measurements. These and many other features and examples are discussed herein.

The communication resources 1230 can include interconnection or network interface components or other suitable devices to communicate with one or more peripheral devices 1204 or one or more databases 1206 via a network 1208. For example, the communication resources 1230 can include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1250 can comprise software, a program, an application, an applet, an app, or other executable code for causing at least any of the processors 1210 to perform any one or more of the methodologies discussed herein. The instructions 1250 can reside, completely or partially, within at least one of the processors 1210 (e.g., within the processor's cache memory), the memory/storage devices 1220, or any suitable combination thereof. Furthermore, any portion of the instructions 1250 can be transferred to the hardware resources 1205 from any combination of the peripheral devices 1204 or the databases 1206. Accordingly, the memory of processors 1210, the memory/storage devices 1220, the peripheral devices 1204, and the databases 1206 are examples of computer-readable and machine-readable media.

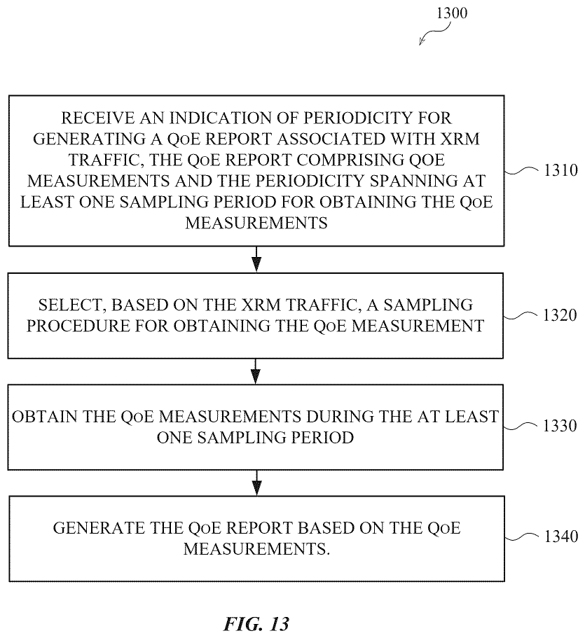

FIG. 13 is a diagram of an example process for mobile-assisted QoE optimization for XRM according to one or more implementations described herein. Process 1300 can be implemented by UE 210. In some implementations, some or all of process 1300 can be performed by one or more other systems or devices, including one or more of the devices of FIG. 2. Additionally, process 1300 can include one or more fewer, additional, differently ordered and/or arranged operations than those shown in FIG. 13. In some implementations, some or all of the operations of process 1300 can be performed independently, successively, simultaneously, etc., of one or more of the other operations of process 1300. As such, the techniques described herein are not limited to a number, sequence, arrangement, timing, etc., of the operations or processes depicted in FIG. 13.

Process 1300 can include receiving an indication of periodicity for generating a QoE report associated with XRM traffic, the QoE report comprising QoE measurements and the periodicity spanning at least one sampling period for obtaining the QoE measurements (block 1310). Process 1300 can include selecting, based on the XRM traffic, a sampling procedure for obtaining the QoE measurements (block 1320). Process 1300 can include obtaining the QoE measurements during the at least one sampling period (block 1330). Process 1300 can include generating the QoE report based on the QoE measurements. (block 1340).

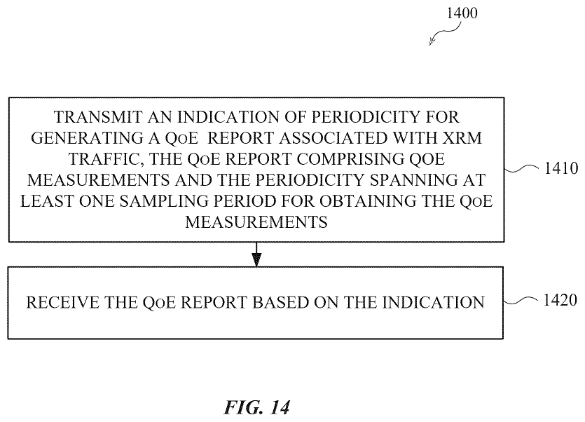

FIG. 14 is a diagram of an example process for mobile-assisted QoE optimization for XRM according to one or more implementations described herein. Process 1400 can be implemented by base station 222. In some implementations, some or all of process 1400 can be performed by one or more other systems or devices, including one or more of the devices of FIG. 2. Additionally, process 1400 can include one or more fewer, additional, differently ordered and/or arranged operations than those shown in FIG. 14. In some implementations, some or all of the operations of process 1400 can be performed independently, successively, simultaneously, etc., of one or more of the other operations of process 1200. As such, the techniques described herein are not limited to a number, sequence, arrangement, timing, etc., of the operations or processes depicted in FIG. 14.

Process 1400 can include transmitting an indication of periodicity for generating a QoE report associated with XRM traffic, the QoE report comprising QoE measurements and the periodicity spanning at least one sampling period for obtaining the QoE measurements (block 1410). Process 1400 can include receiving the QoE report based on the indication (block 1420).

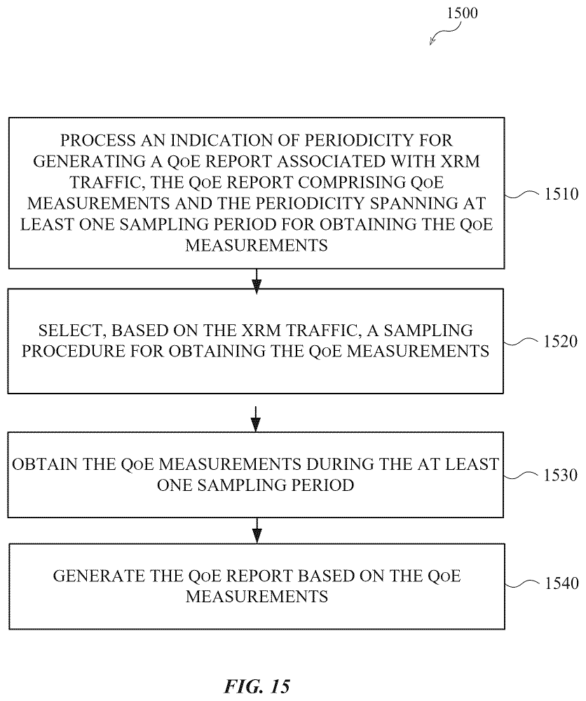

FIG. 15 is a diagram of an example process for mobile-assisted QoE optimization for XRM according to one or more implementations described herein. Process 1400 can be implemented by baseband circuitry 1004. In some implementations, some or all of process 1500 can be performed by one or more other systems or devices, including one or more of the devices of FIG. 2. Additionally, process 1500 can include one or more fewer, additional, differently ordered and/or arranged operations than those shown in FIG. 15. In some implementations, some or all of the operations of process 1500 can be performed independently, successively, simultaneously, etc., of one or more of the other operations of process 1500. As such, the techniques described herein are not limited to a number, sequence, arrangement, timing, etc., of the operations or processes depicted in FIG. 15.

Process 1500 can include processing an indication of periodicity for generating a QoE report associated with extended reality XRM traffic, the QoE report comprising QoE measurements and the periodicity spanning at least one sampling period for obtaining the QoE measurements (block 1510). Process 1500 can include selecting, based on the XRM traffic, a sampling procedure for obtaining the QoE measurements (block 1520). Process 1500 can include obtaining the QoE measurements during the at least one sampling period (block 1530). Process 1500 can include generating the QoE report based on the QoE measurements (block 1540).

Examples and/or implementations herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described. Examples and/or implementations can be implemented by one or more devices as described herein, such as UE 210, base station 222, and baseband circuitry.
In example 1, which can also include one or more of the examples described herein, a UE (e.g., UE 210) (or baseband circuitry) can comprise: a memory; and one or more processors configured to, when executing instructions stored in the memory, cause UE 210 to: receive an indication of a periodicity for generating a QoE report associated with XRM traffic, the QoE report comprising QoE measurements and the periodicity spanning at least one sampling period for obtaining the QoE measurements; select, based on the XRM traffic, a sampling procedure for obtaining the QoE measurements; obtain the QoE measurements during the at least one sampling period; and generate the QoE report based on the QoE measurements.
In example 2, which can also include one or more of the examples described herein, the QoE report is configured to cause an increase or decrease in content quality based on the QoE measurements.
In example 3, which can also include one or more of the examples described herein, the at least one sampling period comprises a plurality of sampling periods, and the sampling procedure comprises performing QoE measurements during each sampling period of the plurality of sampling periods.
In example 4, which can also include one or more of the examples described herein, the sampling procedure is selected based on: the XRM traffic comprising XR video game traffic, and network conditions being at or below an acceptability threshold.
In example 5, which can also include one or more of the examples described herein, the at least one sampling period comprises a plurality of sampling periods, and the sampling procedure comprises performing QoE measurements according to a repeating interval of sampling periods of the plurality of sampling periods.
In example 6, which can also include one or more of the examples described herein, the repeating interval of sampling periods comprises every other sampling period of the plurality of sampling periods.
In example 7, which can also include one or more of the examples described herein, the sampling procedure is selected based on the XRM traffic comprising uplink streaming traffic and downlink streaming traffic.
In example 8, which can also include one or more of the examples described herein, the sampling procedure is selected regardless of network conditions, and the QoE report comprises an average of the QoE measurements.
In example 9, which can also include one or more of the examples described herein, the sampling procedure is selected based on: the XRM traffic comprising video game traffic, and network conditions exceeding an acceptability threshold.
In example 10, which can also include one or more of the examples described herein, the at least one sampling period comprises at least three sampling periods, and the sampling procedure comprises performing QoE measurements during a last two sampling periods of the at least three sampling periods.
In example 11, which can also include one or more of the examples described herein, the sampling procedure is selected based on: the XRM traffic comprising passive streaming traffic, and network conditions being at or below an acceptability threshold.
In example 12, which can also include one or more of the examples described herein, the QoE report comprises an average of the QoE measurements.
In example 13, which can also include one or more of the examples described herein, the at least one sampling period comprises at least three sampling periods, and the sampling procedure comprises performing QoE measurements during a first sampling period and a last sampling period, of the at least three sampling periods.
In example 14, which can also include one or more of the examples described herein, the sampling procedure is selected based on: the XRM traffic comprising live passive streaming traffic, and network conditions being at or below an acceptability threshold.
In example 15, which can also include one or more of the examples described herein, the QoE report comprises an average of the QoE measurements.
In example 16, which can also include one or more of the examples described herein, the at least one sampling period comprises a plurality of sampling periods, and the sampling procedure comprises performing QoE measurements during a last sampling period, of the plurality of sampling periods.
In example 17, which can also include one or more of the examples described herein, the sampling procedure is selected based on: the XRM traffic comprising live passive streaming traffic regardless of network conditions.
In example 18, which can also include one or more of the examples described herein, the QoE report is a first QoE report, and the one or more processors are further configured to cause the UE 210 (or baseband circuitry) to: receive an acknowledgement message in response to indicating the QoE report; indicate a second QoE report; and skip one or more subsequent QoE reports based on not receiving an acknowledgement message following the second QoE report.
In example 19, which can also include one or more of the examples described herein, wherein the QoE report is a first QoE report, and the one or more processors are further configured to cause the UE 210 (or baseband circuitry) to: indicate a third QoE report; and skip one or more subsequent QoE reports based on not receiving an acknowledgement message following the third QoE report.
In example 20, which can also include one or more of the examples described herein, the one or more processors are further configured to cause the UE 210 (or baseband circuitry) to: receive an indication to pause reporting of QoE reports; determine, in response to the indication to pause reporting, whether bytes of stored QoE measurements meet a storage threshold; and discard one or more of the bytes based on whether the bytes of stored QoE measurements meet the storage threshold.
In example 21, which can also include one or more of the examples described herein, a base station (e.g., base station 222) (or baseband circuitry) comprises: a memory; and one or more processors configured to, when executing instructions stored in the memory, cause the base station 222 to: transmit an indication of periodicity for generating a QoE report associated with XRM traffic, the QoE report comprising QoE measurements and the periodicity spanning at least one sampling period for obtaining the QoE measurements; and receive the QoE report based on the indication.
In example 22, which can also include one or more of the examples described herein, the one or more processors are further configured to cause base station 222 (or baseband circuitry) to: adjust one or more conditions based on the QoE report.
In example 23, which can also include one or more of the examples described herein, the one or more processors are further configured to cause base station 222 (or baseband circuitry) to: transmit an indication to pause reporting of QoE reports.
In example 24, which can also include one or more of the examples described herein, baseband circuitry comprises: a memory; and one or more processors configured to, when executing instructions stored in the memory, cause the baseband circuitry to: process an indication of periodicity for generating a QoE report associated with extended reality XRM traffic, the QoE report comprising QoE measurements and the periodicity spanning at least one sampling period for obtaining the QoE measurements; select, based on the XRM traffic, a sampling procedure for obtaining the QoE measurements; obtain the QoE measurements during the at least one sampling period; and generate the QoE report based on the QoE measurements.
In example 25, which can also include one or more of the examples described herein, a method, comprises: receiving an indication of a periodicity for generating a QoE report associated with XRM traffic, the QoE report comprising QoE measurements and the periodicity spanning at least one sampling period for obtaining the QoE measurements; selecting, based on the XRM traffic, a sampling procedure for obtaining the QoE measurements; obtaining the QoE measurements during the at least one sampling period; and generating the QoE report based on the QoE measurements.

The examples discussed above also extend to method, computer-readable medium, and means-plus-function claims and implementations, any of which can include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising. ” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. Baseband circuitry, comprising:
a memory; and
one or more processors configured to, when executing instructions stored in the memory, cause the baseband circuitry to:
process an indication of periodicity for generating a quality of experience (QoE) report associated with extended reality (XR) and media (XRM) traffic, the QoE report comprising QoE measurements and the periodicity spanning at least one sampling period for obtaining the QoE measurements;
select, based on the XRM traffic, a sampling procedure for obtaining the QoE measurements;
obtain the QoE measurements during the at least one sampling period; and
generate the QoE report based on the QoE measurements.

2. The baseband circuitry of claim 1, wherein the QoE report is configured to cause an increase or decrease in content quality based on the QoE measurements.

3. The baseband circuitry of claim 1, wherein:
the at least one sampling period comprises a plurality of sampling periods, and
the sampling procedure comprises performing QoE measurements during each sampling period of the plurality of sampling periods.

4. The baseband circuitry of claim 3, wherein the sampling procedure is selected based on:
the XRM traffic comprising XR video game traffic, and
network conditions being at or below an acceptability threshold.

5. The baseband circuitry of claim 1, wherein:
the at least one sampling period comprises a plurality of sampling periods, and
the sampling procedure comprises performing QoE measurements according to a repeating interval of sampling periods of the plurality of sampling periods.

6. The baseband circuitry of claim 5, wherein the repeating interval of sampling periods comprises every other sampling period of the plurality of sampling periods.

7. The baseband circuitry of claim 5, wherein the sampling procedure is selected based on the XRM traffic comprising uplink streaming traffic and downlink streaming traffic.

8. The baseband circuitry of claim 7, wherein:
the sampling procedure is selected regardless of network conditions, and
the QoE report comprises an average of the QoE measurements.

9. The baseband circuitry of claim 5, wherein the sampling procedure is selected based on:
the XRM traffic comprising video game traffic, and
network conditions exceeding an acceptability threshold.

10. The baseband circuitry of claim 1, wherein:
the at least one sampling period comprises at least three sampling periods, and
the sampling procedure comprises performing QoE measurements during a last two sampling periods of the at least three sampling periods.

11. The baseband circuitry of claim 10, wherein the sampling procedure is selected based on:
the XRM traffic comprising passive streaming traffic, and network conditions being at or below an acceptability threshold.

12. The baseband circuitry of claim 1, wherein:
the at least one sampling period comprises at least three sampling periods, and
the sampling procedure comprises performing QoE measurements during a first sampling period and a last sampling period, of the at least three sampling periods.

13. The baseband circuitry of claim 12, wherein the sampling procedure is selected based on:
the XRM traffic comprising live passive streaming traffic, and
network conditions being at or below an acceptability threshold.

14. The baseband circuitry of claim 1, wherein:
the at least one sampling period comprises a plurality of sampling periods, and
the sampling procedure comprises performing QoE measurements during a last sampling period, of the plurality of sampling periods.

15. The baseband circuitry of claim 14, wherein the sampling procedure is selected based on:
the XRM traffic comprising live passive streaming traffic regardless of network conditions.

16. A user equipment (UE), comprising:
a memory; and
one or more processors configured to, when executing instructions stored in the memory, cause the UE to:
receive an indication of a periodicity for generating a quality of experience (QoE) report associated with extended reality (XR) and media (XRM) traffic, the QoE report comprising QoE measurements and the periodicity spanning at least one sampling period for obtaining the QoE measurements;
select, based on the XRM traffic, a sampling procedure for obtaining the QoE measurements;
obtain the QoE measurements during the at least one sampling period; and
generate the QoE report based on the QoE measurements.

17. The UE of claim 1, wherein:
the QoE report is a first QoE report, and
the one or more processors are further configured to cause the UE to:
receive an acknowledgement message in response to indicating the QoE report;
indicate a second QoE report; and
skip one or more subsequent QoE reports based on not receiving an acknowledgement message following the second QoE report.

18. The UE of claim 1, wherein:
the QoE report is a first QoE report, and
the one or more processors are further configured to cause the UE to:
indicate a third QoE report; and
skip one or more subsequent QoE reports based on not receiving an acknowledgement message following the third QoE report.

19. The UE of claim 1, wherein the one or more processors are further configured to cause the UE to:
receive an indication to pause reporting of QoE reports;
determine, in response to the indication to pause reporting, whether bytes of stored QoE measurements meet a storage threshold; and
discard one or more of the bytes based on whether the bytes of stored QoE measurements meet the storage threshold.

20. A method, comprising:
receiving an indication of a periodicity for generating a quality of experience (QoE) report associated with extended reality (XR) and media (XRM) traffic, the QoE report comprising QoE measurements and the periodicity spanning at least one sampling period for obtaining the QoE measurements;
selecting, based on the XRM traffic, a sampling procedure for obtaining the QoE measurements;
obtaining the QoE measurements during the at least one sampling period; and
generating the QoE report based on the QoE measurements.
